(19) United States
(12) Patent Application Publication
(10) Pub. No.: US 2026/0135471 A1
(43) Pub. Date: May 14, 2026

(54) VOLTAGE REGULATOR WITH LIMITED OUTPUT CURRENT

(71) Applicant: Monolithic Power Systems, Inc., Kirkland, WA (US)

(72) Inventors: Anirudha Atul Mahajan, Roundrock, TX (US); Fangyu Zhang, Hangzhou (CN); Daocheng Huang, San Jose, CA (US)

(21) Appl. No.: 19/370,402

(22) Filed: Oct. 27, 2025

Related U.S. Application Data
(60) Provisional application No. 63/719,393, filed on Nov. 12, 2024.

(51) Int. Cl. H02M 1/32; H02M 1/00; H02M 3/158

(52) U.S. Cl. CPC H02M 1/32; H02M 1/0009; H02M 3/1584

(57) ABSTRACT

A controller for a multiphase voltage regulator in a multi-rail power supply system has a dynamic overcurrent unit and a switch control circuit. The dynamic overcurrent unit provides an overcurrent threshold based on a system-input current which indicates a total input current of the multiphase voltage regulator and at least another voltage regulator. The switch control circuit provides a plurality of switch control signals to control a plurality of switching circuits of the multiphase voltage regulator, such that an output voltage of the multiphase voltage regulator is regulated to a predetermined voltage level and an output current of the plurality of switching circuits is controlled based on the overcurrent threshold.

### CROSS-REFERENCE TO RELATED APPLICATIONS

The present application claims the benefit of U.S. Provisional Application No. 63/719,393, filed on November 12, 2024, which is incorporated herein by reference in its entirety.

### BACKGROUND OF THE INVENTION

### Field of the Invention

The present invention generally relates to electrical components, and more particularly but not exclusively relates to voltage regulators.

### Description of Related Art

The rapid advancement of electronic technologies, particularly in the fields of high-performance computing, telecommunications, and portable consumer devices, has driven a continuous increase in the power demands of integrated circuits. To meet these higher power budgets while maintaining stringent voltage regulation, modern systems employ multiple voltage regulator rails that supply dedicated power domains to various functional units. As the overall power density rises, thermal management has become a critical design concern, since excessive temperature can degrade performance, shorten device life, and compromise reliability.

In conventional voltage regulator architectures, load-line regulation is used to protect the regulator from excessive current draw. This technique reduces the output voltage in proportion to the increase in output current, thereby limiting the maximum power that the regulator can deliver. Although effective for a single-rail configuration, load-line regulation becomes less suitable in multi-rail systems. Each rail contributes to the aggregate thermal load of the package, and when the load-line margins are applied uniformly across all rails, the resulting power budget can be overly conservative. Consequently, the system may operate with significant headroom, leading to sub-optimal utilization of available power and a reduction in overall performance.

### SUMMARY OF THE INVENTION

One embodiment of the present disclosure discloses a controller for a multiphase voltage regulator in a multi-rail power supply system. The controller comprises a dynamic overcurrent unit and a switch control circuit. The dynamic overcurrent unit provides an overcurrent threshold based on a system-input current which indicates a total input current of the multiphase voltage regulator and at least another voltage regulator. The switch control circuit provides a plurality of switch control signals to control a plurality of switching circuits of the multiphase voltage regulator, such that an output voltage of the multiphase voltage regulator is regulated to a predetermined voltage level and an output current of the plurality of switching circuits is controlled based on the overcurrent threshold.

Another embodiment of the present disclosure discloses a control method for a multiphase voltage regulator in a multi-rail power supply system. Providing an overcurrent threshold. Providing a plurality of switch control signals to control a plurality of switching circuits of the multiphase voltage regulator, such that an output voltage of the multiphase voltage regulator is regulated to a predetermined voltage level and an output current of the plurality of switching circuits is controlled based on the overcurrent threshold. In response to a dynamic overcurrent limit function is enabled, dynamically adjusting the overcurrent threshold according to a system-input current which indicates a total input current of the multiphase voltage regulator and at least another voltage regulator.

Yet another embodiment of the present disclosure discloses a multi-rail power supply system. The multi-rail power supply system has an input node, an output node configured to provide a first output voltage, a first voltage regulator and a second voltage regulator. The second voltage regulator has an input node and an output node configured to provide a second output voltage. The input nodes of the first and second voltage regulators are coupled together. The first controller dynamically sets a first overcurrent threshold according to a system-input current indicative of a total input current of at least the first and second voltage regulators, to limit each current flowing through the first plurality of switching circuits.

These and other features of the present disclosure will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals. These drawings are only for illustration purposes, thus may only show part of the devices and are not necessarily drawn to scale.

FIGS. 1A-1B shows schematic diagrams of a multi-rail power supply system 100 in accordance with embodiments of the present invention.

FIGS. 2A-2F show example curves of the overcurrent threshold OCL in accordance with embodiments of the present invention.

FIG. 3 shows a schematic diagram of a dynamic overcurrent unit 30A in accordance with an embodiment of the present invention.

FIG. 4 shows a register map 400 in accordance with an embodiment of the present invention.

FIG. 5 shows a power limit method 500 in accordance with an embodiment of the present invention.

FIG. 6 shows a schematic diagram of a dynamic overcurrent unit 30B in accordance with an embodiment of the present invention.

FIG. 7 shows a register map 700 in accordance with an embodiment of the present invention.

FIG. 8 shows a power limit method 800 in accordance with an embodiment of the present invention.

FIG. 9 shows a schematic of a dynamic overcurrent unit 30C in accordance with an embodiment of the present invention.

FIG. 10 shows a schematic diagram of a multiphase voltage regulator 1000 in accordance with an embodiment of the present invention.

FIG. 11 shows a schematic diagram of a switch control circuit 50A in accordance with an embodiment of the present invention.

FIGS. 12A-12C show timing diagrams of the switch control circuit 50A in accordance with embodiments of the present invention.

FIG. 13 shows a schematic diagram of a switch control circuit 50B in accordance with an embodiment of the present invention.

FIG. 14 shows a timing diagram of the multiphase voltage regulator 1000 in accordance with an embodiment of the present invention.

FIG. 15 shows a control method 1500 for a multiphase voltage regulator in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

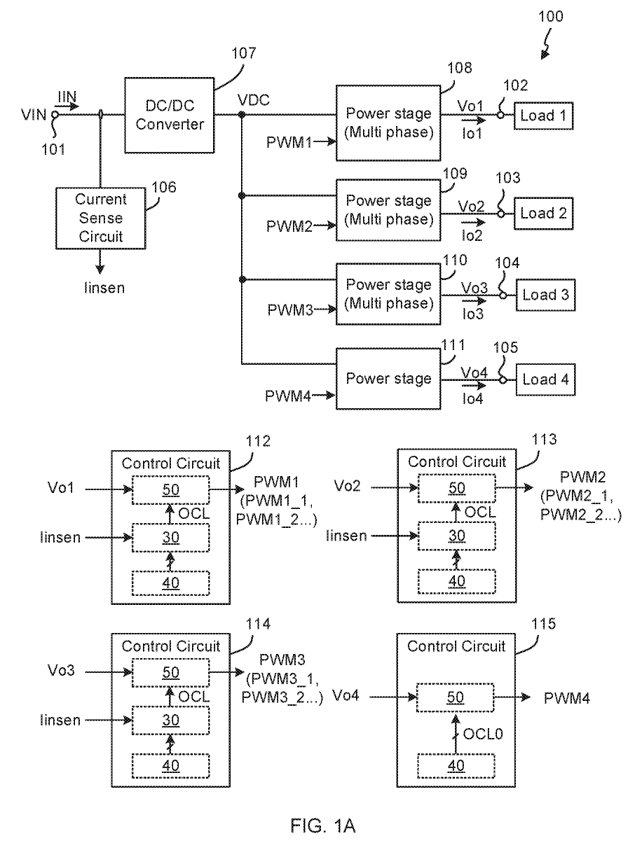

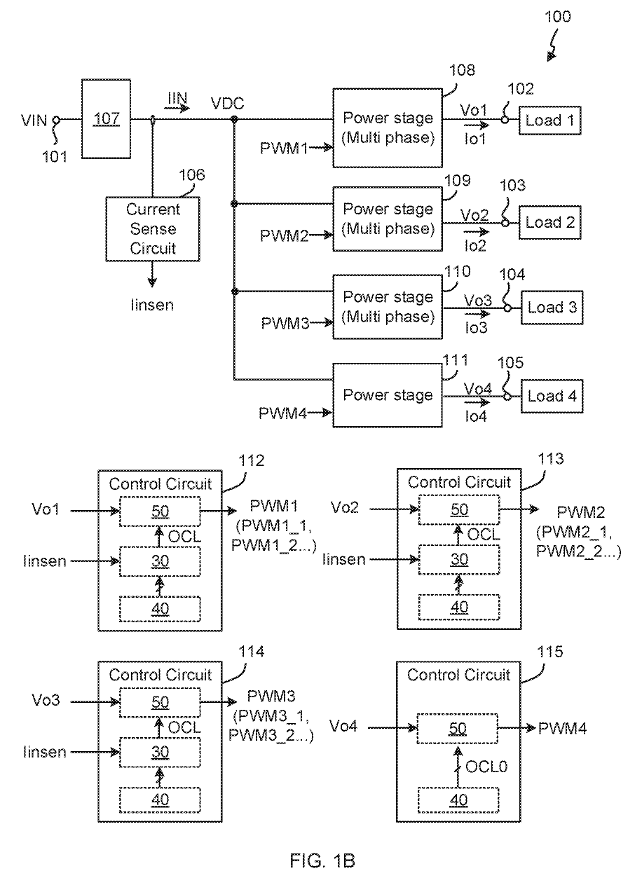

FIGS. 1A-1B shows schematic diagrams of a multi-rail power supply system 100 in accordance with embodiments of the present invention. The multi-rail power supply system 100 receives an input voltage VIN at an input node 101 and delivers more than one output voltages (e.g., four output voltages Vo1-Vo4) to the corresponding output nodes (e.g., 102-105), each of which powers a separate load (i.e., load 1, load 2, load 3, load 4). In one embodiment, the loads comprise different functional units (e.g., of an Application Specific Integrated Circuits, ASIC), that consume power from the respective rails.

In the example of FIG. 1A, a system-input current IIN indicating a total input current of a plurality of voltage regulators of the muti-rail power supply system flows into the multi-rail power supply system 100 from node 101 and is a key parameter monitored for subsequent control operations. The plurality of voltage regulators provides the output voltages Vo1-Vo4. Each voltage regulator is formed by a power stage (i.e., 108, 109, 110, 111 shown in FIG. 1A) and a control circuit (i.e., 112, 113, 114, 115 as shown in FIG. 1A). FIG. 1A shows four output rails (e.g., the power stages 108, 109, 110, 111) to generate the output voltages Vo1-Vo4 as one example, the multi-rail power supply system 100 can be extended to provide any number of output rails by adding or removing power stages as needed. In one embodiment, each power stage may include one or more switching circuits coupled in parallel to provide a corresponding output voltage and Each switching circuit represents one phase. For example, each of the power stages 108-110 may have more than one switching circuits to form multiphase voltage regulator together with corresponding control circuit 112-114 respectively, and the power stage 111 may have one switching circuit.

In the example of FIG. 1A, a direct current to direct current (DC/DC) converter 107 as an intermediate converter receives the input voltage VIN and converts it to a DC bus voltage VDC. The power stages 108-111 are driven by the DC bus voltage VDC to generate the output voltages Vo1-Vo4 respectively. In some configurations, the DC/DC converter 107 may be omitted, allowing the power stages 108-111 to connect directly to the input node 101.

Each controller (i.e.,112, 113, 114, 115 shown in FIG. 1A) monitors the output voltage of its associated power stage (i.e., 108, 109, 110, 111 shown in FIG. 1A) and generates the corresponding switch control signal array (i.e., PWM1, PWM2, PWM3, PWM4 shown in FIG. 1A). The switch control signal array PWM1 includes a plurality of switch control signals PWM1_1, PWM1_2, and so on. The switch control signal array PWM2 includes a plurality of switch control signals PWM2_1, PWM2_2, and so on. The switch control signal array PWM3 includes a plurality of switch control signals PWM3_1, PWM3_2, and so on. Part of the controllers may control output currents of corresponding power stages respectively via monitoring the system-input current IIN for limiting system-level thermal dissipation. For example, the controller 112 controls a current Io1, the controller 113 controls a current Io2, and the controller 114 controls a current Io3 based on the system-input current IIN respectively.

In one embodiment, each of the controllers 112-114 uses the system-input current IIN as a real-time indicator to adjust an overcurrent threshold OCL, thereby limiting per phase current delivered through each switching circuit. By doing so, the multi-rail power supply system 100 can more effectively constrain the total power dissipation in response to dynamic load conditions, thereby enhancing performance while preventing excessive temperature rise. In one embodiment, the overcurrent threshold OCL decreases as the system-input current IIN rises. That means in a normal load condition, the overcurrent threshold OCL will not limit output power provided by the associated power stage, only when the system-input current IIN increases, e.g., caused by increasing of a system level power, then the overcurrent threshold OCL will drop to limit the output power provided by the associated power stage.

As shown in FIG. 1A, a current sense circuit 106 is employed to sense the system-input current IIN and provide a current sense signal Iinsen, the controllers 112-114 receive the current sense signal Iinsen and dynamically adjust its overcurrent threshold OCL respectively based on the current sense signal Iinsen.

In one example, each controller 112-114 has a dynamic overcurrent unit 30 to independently adjust its own overcurrent threshold OCL based on the input current sense signal Iinsen. This allows each power stage 108-110 to adaptively limit its individual output current in response to changes in the system-input current IIN. The controller 115 provides an overcurrent threshold OCL0, which is predetermined and will not dynamically adjust based on the system-input current IIN. This suggests that the power stage 111 controlled by the controller 115 might be less critical in terms of thermal management or has specific operational needs.

In one example, each controller 112-115 has a switch control circuit 50 configured to provide the corresponding plurality of switch control signals, to control switch devices of the associated power stage based on the associated output voltage and the associated overcurrent threshold, ensuring both output voltage regulation and per phase current limiting. A memory 40 within each controller 112-115 holds settings for these thresholds, allowing for fine-tuning of their responsiveness. In one embodiment, each controller 112-115 has the memory 40 including a plurality of registers. The memory 40 in each controller 112-114 is configured to store settings for the dynamic overcurrent unit 30, and the memory 40 in the controller 115 is configured to determine the overcurrent threshold OCL0.

In the example of FIG. 1B, the system-input current IIN is an output current of the DC/DC converter 107 which provides total input currents for the power stages 108-111 and is sensed by the current sense circuit 106.

The multi-rail power supply system 100 of FIGS. 1A-1B demonstrates how system‑input current sensing can be leveraged to coordinate the over‑current limits of multiple voltage regulators. By dynamically adjusting the overcurrent threshold OCL, the multi-rail power supply system 100 achieves a system-level thermal balance. Each rail retains sufficient headroom for performance, yet the total power dissipation is constrained to avoid overheating.

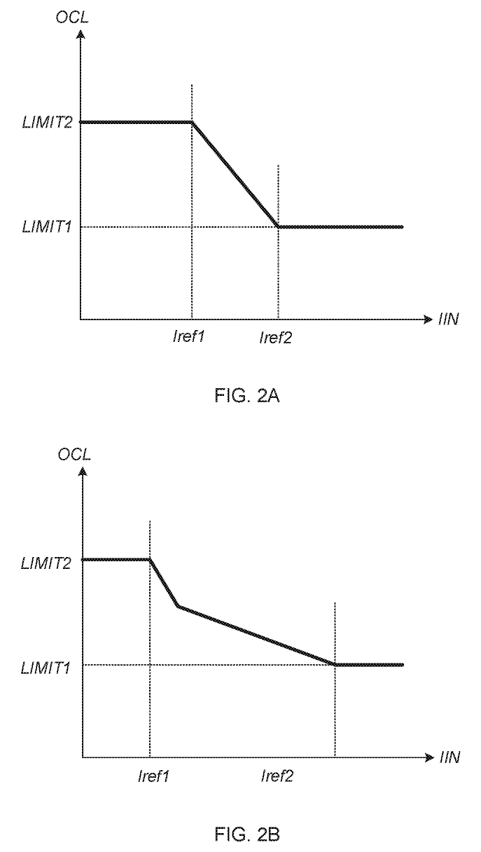

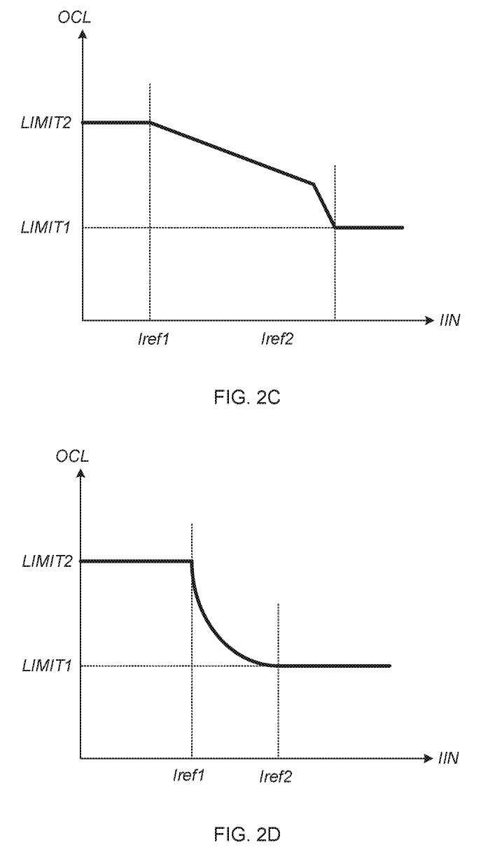

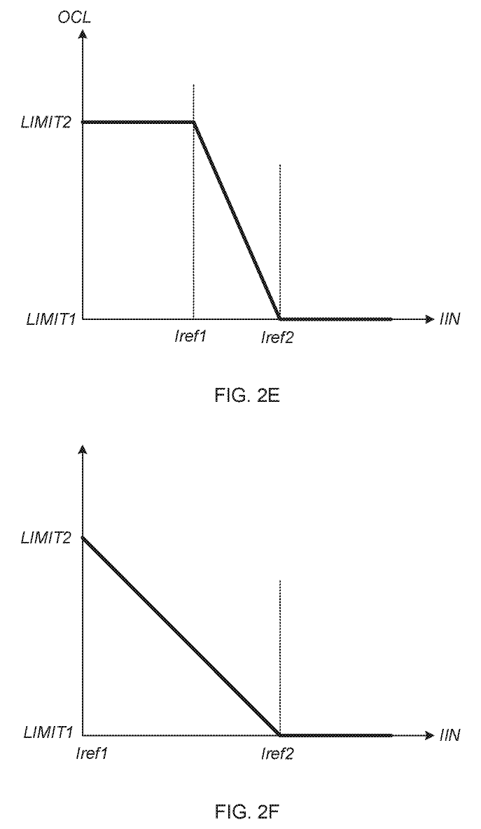

FIGS. 2A-2F shows example curves of the overcurrent threshold OCL in accordance with an embodiment of the present invention. One with ordinary skill in the art should understand that the overcurrent threshold OCL is not limited by FIGS. 2A-2F, other possible relationships between the overcurrent threshold OCL and the system-input current IIN may also be employed due to different applications. FIG. 2A shows that when the system-input current IIN is less than a threshold Iref1, the overcurrent threshold OCL maintains at a value LIMIT2. When the system-input current IIN is higher than the threshold Iref1 and is less than a threshold Iref2, the overcurrent threshold OCL decreases with a slope in response to rising of the system-input current IIN. When the system-input current IIN is higher than the threshold Iref2, the overcurrent threshold OCL maintains at a value LIMIT1. FIGS. 2B-2D shows that when the system-input current IIN is higher than the threshold Iref1 and is less than the threshold Iref2, the overcurrent threshold OCL decreases nonlinear in response to rising of the system-input current IIN. FIGS. 2E shows that the value LIMIT1 may be zero. FIG. 2F shows that both the value LIMIT1 and the threshold Iref1 may be zero.

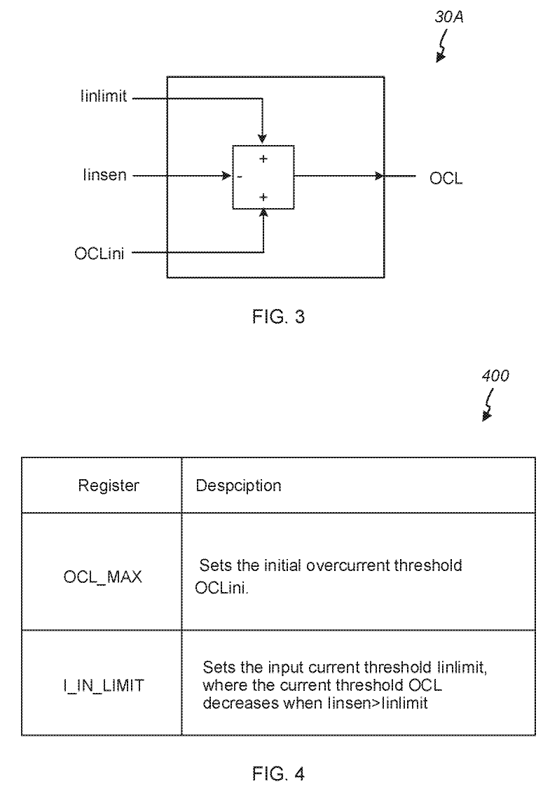

FIG. 3 shows a schematic diagram of a dynamic overcurrent unit 30A in accordance with an embodiment of the present invention. The dynamic overcurrent unit 30A provides the overcurrent threshold OCL based on the current sense signal Iinsen, an initial overcurrent threshold OCLini, and an input current threshold Iinlimit.

In one example, when the current sense signal Iinsen is less than the input current threshold Iinlimit, then the overcurrent threshold OCL maintains at the initial overcurrent threshold OCLini. In one example, when the current sense signal Iinsen is higher than the input current threshold Iinlimit, the overcurrent threshold OCL varies from the initial overcurrent threshold OCLini according to a difference between the input current threshold Iinlimit and the current sense signal Iinsen (Iinlimit-Iinsen).

FIG. 4 shows a register map 400 in accordance with an embodiment of the present invention. The register map 400 may be stored in the memory 40 of the controller 112-114. As shown in FIG. 4, the register map 400 comprises a data OCL_MAX and a data I_IN_LIMIT. The data OCL_MAX is used to set the initial overcurrent threshold OCLini. The data I_IN_LIMIT is used to set the input current threshold Iinlimit, where the current threshold OCL decreases when the current sense signal Iinsen is higher than the input current threshold Iinlimit.

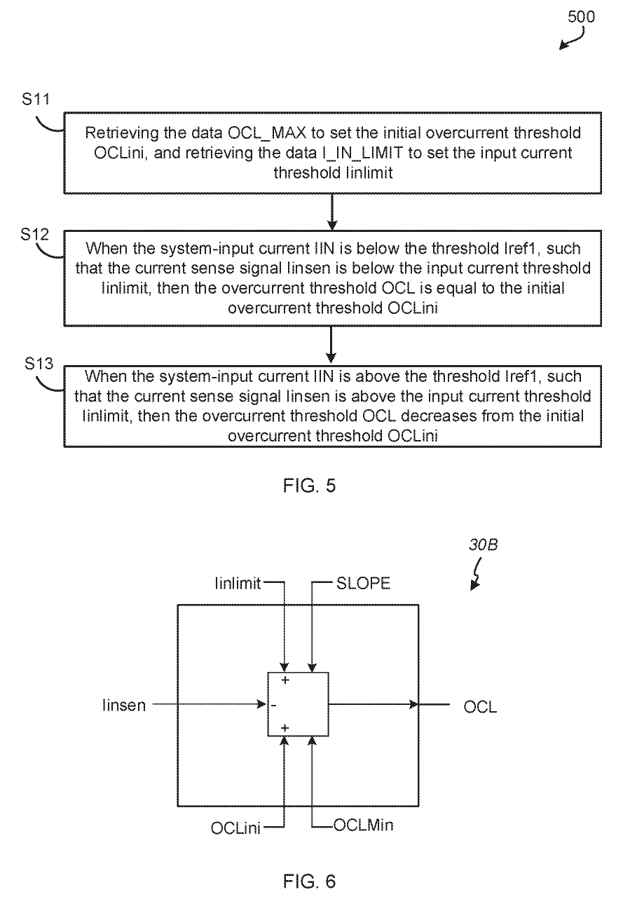

FIG. 5 shows a power limit method 500 in accordance with an embodiment of the present invention. The power limit method 500 comprises steps S11-S13 and may be executed by the control circuits 112-114 having the register map 400.

At step S11, retrieving the data OCL_MAX to set the initial overcurrent threshold OCLini, and retrieving the data I_IN_LIMIT to set the input current threshold Iinlimit. At step S12, when the system-input current IIN is below the threshold Iref1, such that the current sense signal Iinsen is below the current threshold Iinlimit, then the overcurrent threshold OCL is equal to the initial overcurrent threshold OCLini. At step S13, when the system-input current IIN is above the threshold Iref1, such that the current sense signal Iinsen is above the input current threshold Iinlimit, then the overcurrent threshold OCL decreases from the initial overcurrent threshold OCLini.

FIG. 6 shows a schematic diagram of a dynamic overcurrent unit 30B in accordance with an embodiment of the present invention. In one embodiment, the dynamic overcurrent unit 30B provides the overcurrent threshold OCL further based on a minimum overcurrent threshold OCLMin. When the current sense signal Iinsen is higher than the input current threshold Iinlimit, the overcurrent threshold OCL decreases until reaching the minimum overcurrent threshold OCLMin, after which the overcurrent threshold OCL is held constant at the minimum overcurrent threshold OCLMin and will not decrease any further. In one embodiment, the dynamic overcurrent unit 30B provides the overcurrent threshold OCL further based on a decreasing rate SLOPE. When the current sense signal Iinsen rises above the input current threshold Iinlimit, the overcurrent threshold OCL decreases with the decreasing rate SLOPE.

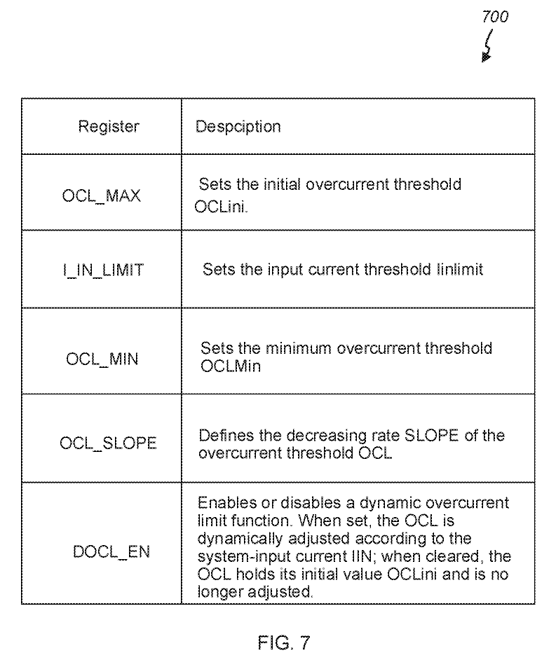

FIG. 7 shows a register map 700 in accordance with an embodiment of the present invention. Compared with the register map 400, the register map 700 further comprises a data OCL_MIN, and a data OCL_SLOPE. The data OCL_MIN is used to set the minimum overcurrent threshold OCLMin. The data OCL_SLOPE is used to set the decreasing rate SLOPE of the overcurrent threshold OCL. The register map 700 futher has a data DOCL_EN, which is used to control enablement of a dynamic overcurrent limit function. When the dynamic overcurrent limit function is enabled, the overcurrent threshold OCL is dynamically adjusted according to the system-input current IIN. When the dynamic overcurrent limit function is disabled, the overcurrent threshold OCL holds its initial overcurrent threshold OCLini and is no longer adjusted according to the system-input current IIN. These additional registers give the multi-rail power supply system 100 fine-grained control over the dynamic overcurrent limit behavior, allowing the voltage regulator to respond more aggressively or conservatively to changes in overall power demand.

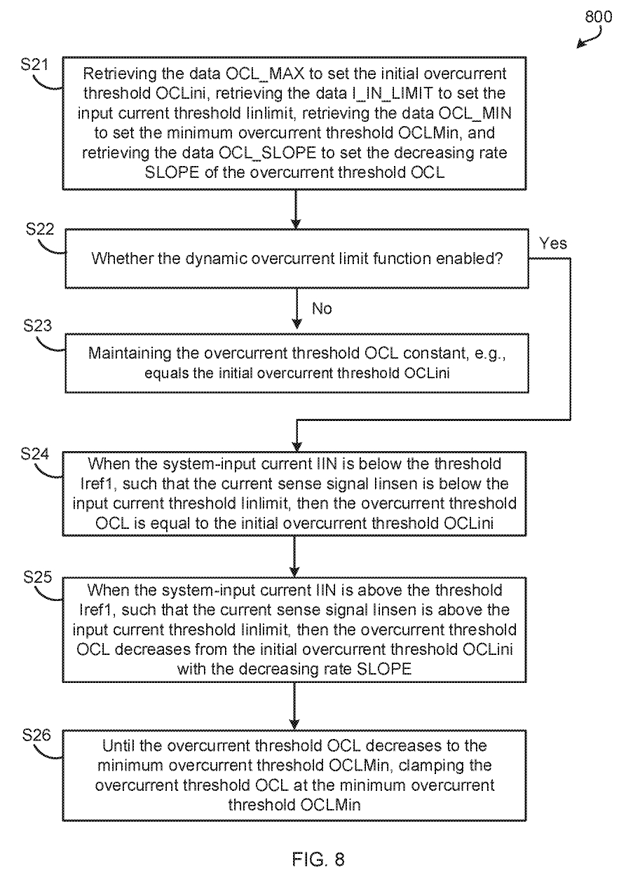

FIG. 8 shows a power limit method 800 in accordance with an embodiment of the present invention. The power limit method 800 comprises steps S21-S26 and may be executed by the control circuits 112-114 having the register map 700.

At step S21, retrieving the data OCL_MAX to set the initial overcurrent threshold OCLini, retrieving the data I_IN_LIMIT to set the input current threshold Iinlimit, retrieving the data OCL_MIN to set the minimum overcurrent threshold OCLMin, and retrieving the data OCL_SLOPE to set the decreasing rate SLOPE of the overcurrent threshold OCL. At step S22, judging whether the dynamic overcurrent limit function is enabled. If the dynamic overcurrent limit function is disabled, then go to step S23. If the dynamic overcurrent limit function is enabled, then go to steps S24-S26. At step S23, the dynamic overcurrent limit function is disabled to maintain the overcurrent threshold OCL constant, e.g., equals the initial overcurrent threshold OCLini. At step S24, when the system-input current IIN is below the threshold Iref1, such that the current sense signal Iinsen is below the input current threshold Iinlimit, then the overcurrent threshold OCL is equal to the initial overcurrent threshold OCLini. At step S25, when the system-input current IIN is above the threshold Iref1, such that the current sense signal Iinsen is above the input current threshold Iinlimit, the overcurrent threshold OCL decreases from the initial overcurrent threshold OCLini with the decreasing rate SLOPE. At step S26, until the overcurrent threshold OCL decreases to the minimum overcurrent threshold OCLMin, clamping the overcurrent threshold OCL at the minimum overcurrent threshold OCLMin.

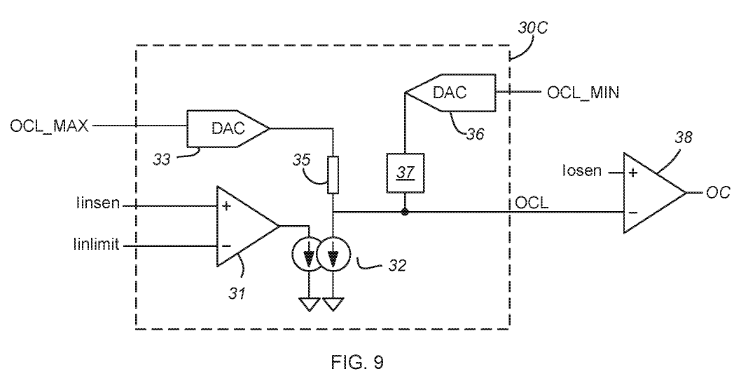

FIG. 9 shows a schematic of a dynamic overcurrent unit 30C in accordance with an embodiment of the present invention. Referring to FIG. 9, the overcurrent threshold OCL is generated based on the stored data OCL_MAX when the current sense signal Iinsen is below the input current threshold Iinlimit, via a DAC (digital to analog converter) 33 and a resistor 35. A comparator 31 is configured to compare the current sense signal Iinsen with the input current threshold limit IinIimit. When the current sense signal Iinsen is above the input current threshold limit Iinlimit, an output of the comparator controls a current source 32 pulling down the overcurrent threshold OCL. A DAC 36 provides the minimum overcurrent threshold OCLMin based on the stored data OCL_MIN. A clamp circuit 37 is configured to clamp the overcurrent threshold OCL no lower than the minimum overcurrent threshold OCLMin.

In one example, the overcurrent threshold OCL is compared to a current sense signal Iosen via a comparator 38 to provide an overcurrent indicating signal OC. The current sense signal Iosen may represent the output current (e.g., Io1, Io2, Io3), or a phase current flowing through a switching circuit. Once the current sense signal Iosen exceeds the overcurrent threshold OCL, the overcurrent indicating signal OC is active (e.g., logical high) to indicate that an overcurrent condition has occurred. The controller can then react by temporarily shutting down the power stage to keep the output current within safe limits.

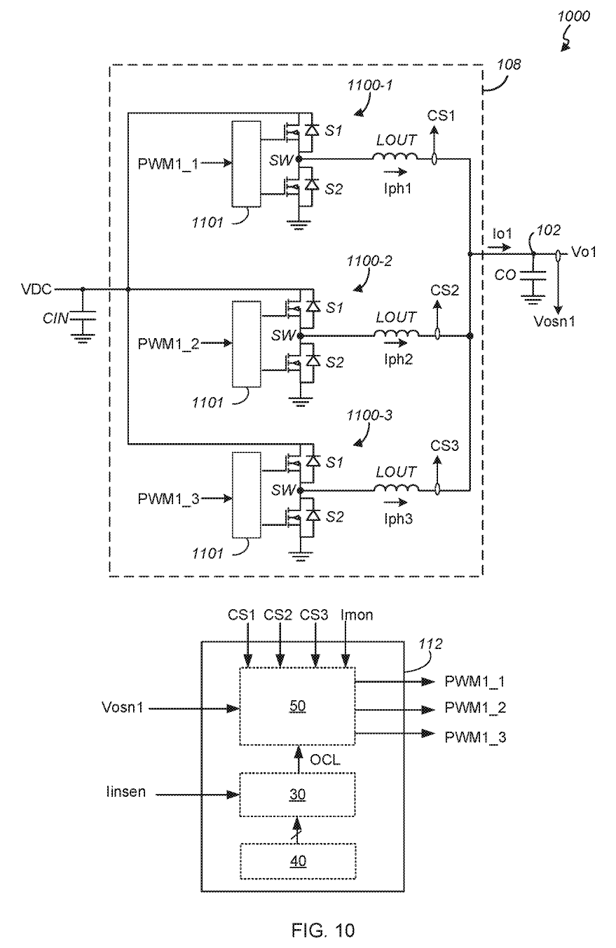

FIG. 10 shows a schematic diagram of a multiphase voltage regulator 1000 in accordance with an embodiment of the present invention. In the example of FIG. 10, the multiphase voltage regulator 1000 is implemented using the power stage 108 and the controller 112. The design and operation of the multiphase voltage regulator 1000 serve as the reference embodiment; all other rail voltage regulators that employ the power stages 109-110 together with their associated controllers 113-114 are constructed in the same manner and are therefore omitted from the description for brevity.

The power stage 108 includes a plurality of phase circuits 1100 (i.e., switching circuits 1100-1,1100-2,1100-3 shown in FIG. 10). In the example of FIG. 10, the power stage 108 has three phase circuits as one example. In other examples, more or less phase circuits could be used for different applications. Each phase circuit includes a high side switch S1, a low side switch S2, a switch node SW formed by the high side switch S1 and the low side switch S2, an output inductor LOUT coupled between the switch node SW and the output node 102, and a driver 1101 configured to control turning on and turning off of the high side switch S1 and the low side switch S2 based on a corresponding switch control signal (PWM1_1, PWM1_2, PWM1_3). A phase current Iph1 flows through the phase circuit 1100-1, a phase current Iph2 flows through the phase circuit 1100-2, and a phase current Iph3 flows through the phase circuit 1100-3.

In one example, the switch control circuit 50 provides the switch control signals PWM1_1, PWM1_2, PWM1_3 based on the overcurrent threshold OCL, the output voltage Vo1, and the phase currents Iph1-Iph3. In one example, the switch control circuit 50 receives a voltage sense signal Vosn1 indicative of the output voltage Vo1, a current sense signal CS1 indicative of the phase current Iph1, a current sense signal CS2 indicative of the phase current Iph2, a current sense signal CS3 indicative of the phase current Iph3, and provides the switch control signals PWM1_1, PWM1_2, PWM1_3 to regulate the output voltage Vo1, while to limit each phase current (Iph1, Iph2, Iph3) being less than the overcurrent threshold OCL.

In another example, a total phase current Isum (i.e., Iph1+Iph2+Iph3) provided by phase circuits 1100 is also limited based on the overcurrent threshold OCL. The switch control circuit 50 receives a current sense signal Imon indicative of the total phase current Isum provided by the phase circuits 1100 and provides the switch control signals PWM1_1, PWM1_2, PWM1_3 further based on the current sense signal Imon.

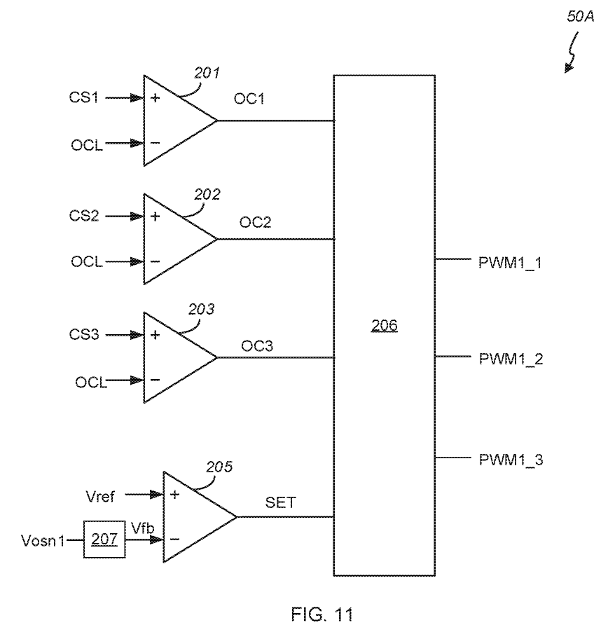

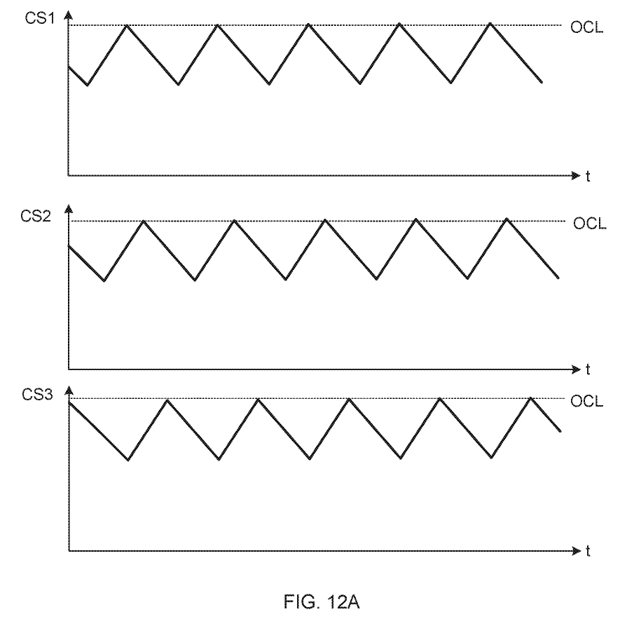

FIG. 11 shows a schematic diagram of a switch control circuit 50A in accordance with an embodiment of the present invention. The switch control circuit 50A has comparators 201-203. The comparator 201 provides an overcurrent indicating signal OC1 based on the current sense signal CS1 and the overcurrent threshold OCL. When the current sense signal CS1 is above the overcurrent threshold OCL, the overcurrent indicating signal OC1 is active to indicate that the phase circuit 1100-1 is under an overcurrent condition. The comparator 202 provides an overcurrent indicating signal OC2 based on the current sense signal CS2 and the overcurrent threshold OCL. When the current sense signal CS2 is above the overcurrent threshold OCL, the overcurrent indicating signal OC2 is active to indicate that the phase circuit 1100-2 is under the overcurrent condition. The comparator 203 provides an overcurrent indicating signal OC3 based on the current sense signal CS3 and the overcurrent threshold OCL. When the current sense signal CS3 is above the overcurrent threshold OCL, the overcurrent indicating signal OC3 is active to indicate that the phase circuit 1100-3 is under the overcurrent condition. An output circuit 206 provides the switch control signals PWM1_1, PWM1_2, PWM1_3 based on the overcurrent indicating signals OC1-OC3 and a set signal SET generated based on a difference or a comparison result between a feedback signal Vfb indicative of the output voltage Vo1 and a reference signal Vref. In one example, a feedback circuit 207 receives the voltage sense signal Vosn1 and provides the feedback signal Vfb based on the voltage sense signal Vosn1. A comparator or an amplifier 205 is configured to provide the set signal SET. When the overcurrent indicating signals OC1-OC3 are inactive, the switch control signals PWM1_1, PWM1_2, PWM1_3 are generated in response to the set signal SET to regulate the output voltage Vo1. When one of the overcurrent indicating signals OC1-OC3 is active, a corresponding switch control signal is configured to turn off a corresponding phase circuit. For example, when the overcurrent indicating signal OC1 is active to indicate that the current sense signal CS1 is above the overcurrent threshold OCL, the switching control signal PWM1_1 becomes inactive to turn off the phase circuit 1100-1 (e.g., turn off the high side switch S1), or the switch control signal PWM1_1 remains inactive before the overcurrent condition of the phase circuit 1100-1 is cleared.

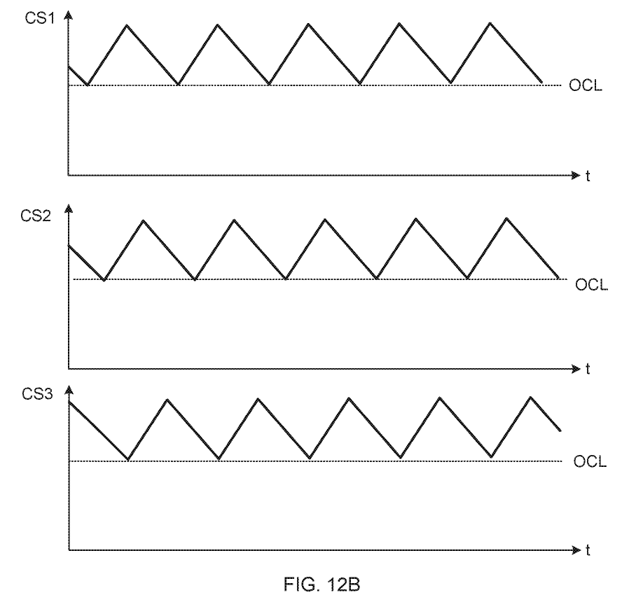

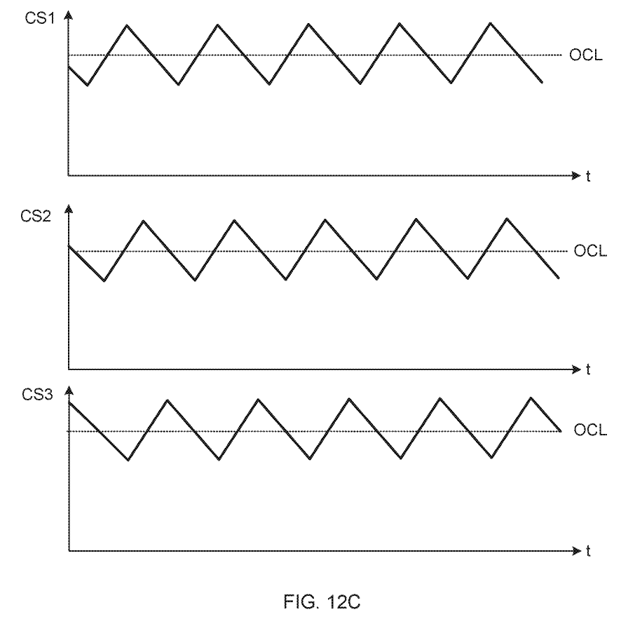

FIGS. 12A-12C show timing diagrams of the switch control circuit 50A in accordance with embodiments of the present invention. FIG. 12A shows that peak of each current sense signal CS1-CS3 is constrained by the overcurrent threshold OCL. FIG. 12B shows that valley of each current sense signals CS1-CS3 is constrained to by the overcurrent threshold OCL. FIG. 12C shows that average of each current sense signal CS1-CS3 is constrained by the overcurrent threshold OCL.

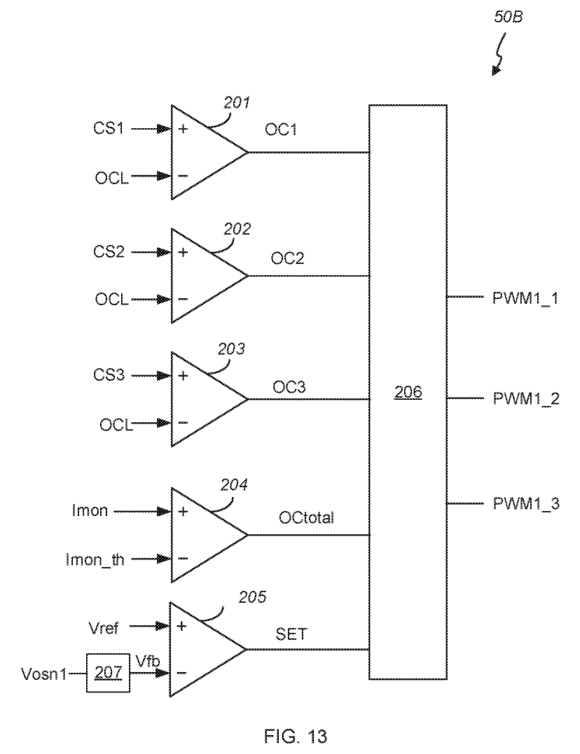

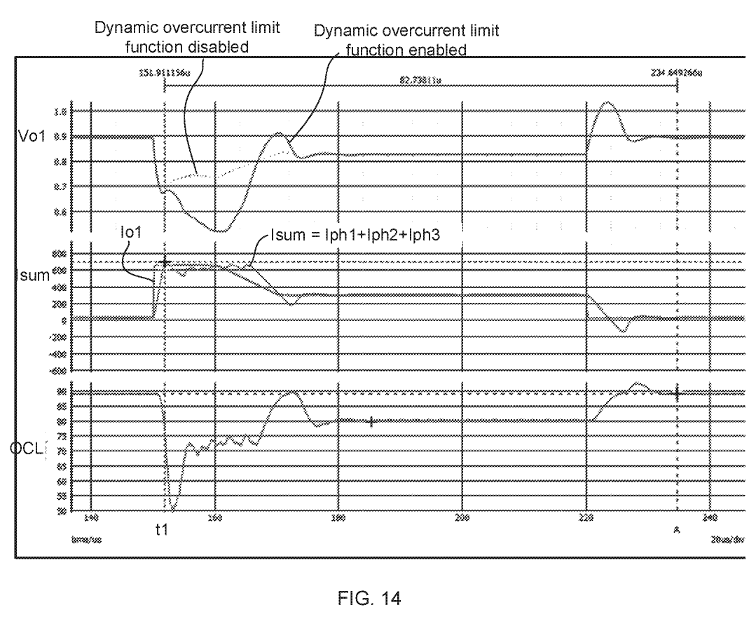

FIG. 13 shows a schematic diagram of a switch control circuit 50B in accordance with an embodiment of the present invention. The switch control circuit 50B further comprises a comparator 204. The comparator 204 provides an overcurrent indicating signal OCtotal based on the current sense signal Imon and an overcurrent threshold Imon_th. In one example, the current sense signal Imon is generated based on the sum of the current sense signals CS1-CS3. And the output circuit 206 provides the switch control signals PWM1_1, PWM1_2, PWM1_3 further based on the overcurrent indicating signal OCtotal. When the overcurrent indicating OCtotal is active to indicate that the current sense signal is above the overcurrent threshold Imon_th, all of the switch control signals PWM1_1, PWM1_2, PWM1_3 are inactive to keep all of the phase circuits 1100-1, 1100-2, 1100-3 off. Until the overcurrent indicating OCtotal is inactive to indicate that the overcurrent condition is cleared, the switch control signals PWM1_1, PWM1_2, PWM1_3 resumes normal to regulate the output voltage Vo1.

FIG. 14 shows a timing diagram of the multiphase voltage regulator 1000 in accordance with an embodiment of the present invention. From top to below, FIG. 14 displays (i) the output voltage Vo1, (ii) the total phase current Isum, and (iii) the overcurrent threshold OCL. For comparison, the dashed line shows the output voltage Vo1 when the dynamic overcurrent limit function is disabled, such that the overcurrent threshold OCL is held constant. When the dynamic overcurrent limit function is enabled, the overcurrent threshold OCL is allowed to vary with the system-input current IIN, and the total phase current Isum is clamped by the variable overcurrent threshold OCL which is determined by the system-input current IIN. Compared with a configuration in which the dynamic overcurrent limit function is disabled, enabling the dynamic overcurrent limit function results in more pronounced drop in the output voltage Vo1. As shown in FIG. 14, at time t1, the load draws a higher output current Io1, and then the overcurrent threshold OCL falls, consequently the total phase current Isum is limited by the reduced overcurrent threshold OCL, the output voltage Vo1 decreases, and thus the delivered power is limited.

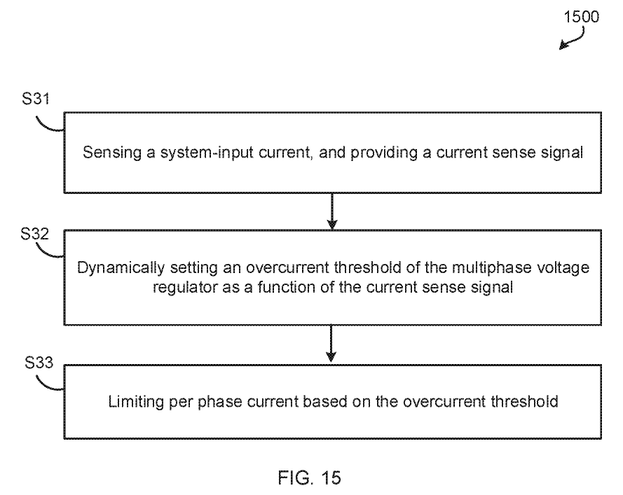

FIG. 15 shows a control method 1500 for a multiphase voltage regulator in accordance with an embodiment of the present invention. The control method 1500 has steps S31-S33. The multiphase voltage regulator includes a power stage comprising a plurality of phase circuits and a controller.

At step S31, sensing a system-input current which indicates a total input current of the multiphase voltage regulator and at least another voltage regulator, and providing a current sense signal. At step S32, dynamically setting an overcurrent threshold of the multiphase voltage regulator as a function of the current sense signal. At step S33, limiting per phase current based on the overcurrent threshold.

Note that in the flow charts described above, the box functions may also be implemented with different order. Two successive box functions may be executed meanwhile, or sometimes the box functions may be executed in a reverse order.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A controller for a multiphase voltage regulator in a multi-rail power supply system, comprising:
a dynamic overcurrent unit configured to provide an overcurrent threshold based on a system-input current which indicates a total input current of the multiphase voltage regulator and at least another voltage regulator; and
a switch control circuit configured to provide a plurality of switch control signals to control a plurality of switching circuits of the multiphase voltage regulator, such that an output voltage of the multiphase voltage regulator is regulated to a predetermined voltage level and an output current of the plurality of switching circuits is controlled based on the overcurrent threshold.

2. The controller of claim 1, wherein the controller is configured to limit each current delivered through each of the plurality of switching circuits in response to the overcurrent threshold.

3. The controller of claim 1, wherein the overcurrent threshold maintains at a first value in response to the system-input current being less than a first threshold, and the overcurrent threshold decreases as the system-input current rises in response to the system-input current being higher than the first threshold.

4. The controller of claim 1, further comprising:
a memory configured to store a first data used to set an initial overcurrent threshold and a second data used to set an input current threshold; wherein
the dynamic overcurrent unit is configured to receive a current sense signal indicating the system-input current, the initial overcurrent threshold and the input current threshold, and to provide the overcurrent threshold in response to the current sense signal, the initial overcurrent threshold and the input current threshold.

5. The controller of claim 4, wherein the overcurrent threshold maintains at the initial overcurrent threshold in response to the current sense signal being less than the input current threshold, and the overcurrent threshold varies from the initial overcurrent threshold according to a difference between the input current threshold and the current sense signal in response to the current sense signal being higher than the input current threshold.

6. The controller of claim 4, wherein the memory further configured to store a third data which is used to set a minimum overcurrent threshold which is used to set a minimum of the overcurrent threshold.

7. The controller of claim 4, wherein the memory further configured to store a fourth data which is used to set a decreasing rate of the overcurrent threshold.

8. The controller of claim 1, wherein the dynamic overcurrent unit comprises:
a first digital to analog converter configured to provide an initial overcurrent threshold based on a first data;
a current source; and
a comparator configured to compare a current sense signal indicative of the system-input current with an input current threshold; wherein
when the current sense signal is above the input current threshold limit, an output of the comparator controls the current source pulling down the overcurrent threshold.

9. The controller of claim 8, wherein the dynamic overcurrent unit further comprises:
a second digital to analog converter configured to provide a minimum overcurrent threshold based on a second data; and
a clamp circuit configured to clamp the overcurrent threshold no lower than the minimum overcurrent threshold.

10. The controller of claim 1, further comprising:
a plurality of comparison circuits, configured to compare a plurality of phase current sense signals with the overcurrent threshold respectively to provide a plurality of overcurrent indicating signal; wherein
in response to one of the plurality of phase sense signals is higher than the overcurrent threshold, the is configured to turn off a corresponding switching circuit.

11. A control method for a multiphase voltage regulator in a multi-rail power supply system, comprising:
providing an overcurrent threshold;
providing a plurality of switch control signals to control a plurality of switching circuits of the multiphase voltage regulator, such that an output voltage of the multiphase voltage regulator is regulated to a predetermined voltage level and an output current of the plurality of switching circuits is controlled based on the overcurrent threshold; and
in response to a dynamic overcurrent limit function is enabled, dynamically adjusting the overcurrent threshold according to a system-input current which indicates a total input current of the multiphase voltage regulator and at least another voltage regulator.

12. The control method of claim 11, further comprising:
in response to the dynamic overcurrent limit function is disabled, maintaining the overcurrent threshold constant.

13. The control method of claim 11, further comprising:
limiting each current delivered through each of the plurality of switching circuits in response to the overcurrent threshold.

14. The control method of claim 11, further comprising:
receiving a current sense signal indicating the system-input current;
maintaining the overcurrent threshold at an initial overcurrent threshold when the current sense signal is less than an input current threshold; and
decreasing the overcurrent threshold from the initial overcurrent threshold when the current sense signal is higher than the input current threshold.

15. The control method of claim 14, further comprising:
retrieving a first data to set the initial overcurrent threshold; and
retrieving a second data to set the input current threshold.

16. The control method of claim 11, further comprising:
receiving a current sense signal indicating the system-input current;
maintaining the overcurrent threshold at an initial overcurrent threshold when the current sense signal is less than an input current threshold; and
varying the overcurrent threshold according to a difference between the input current threshold and the current sense signal when the current sense signal is higher than the input current threshold.

17. A multi-rail power supply system, comprising:
a first voltage regulator comprising an input node, an output node configured to provide a first output voltage, a first plurality of switching circuits and a first controller; and
a second voltage regulator comprising an input node and an output node configured to provide a second output voltage, wherein the input nodes of the first and second voltage regulators are coupled together; wherein
the first controller is configured to dynamically set a first overcurrent threshold according to a system-input current indicative of a total input current of at least the first and second voltage regulators, to limit each current flowing through the first plurality of switching circuits.

18. The multi-rail power supply system of claim 17, wherein the first controller further comprises:
a dynamic overcurrent unit configured to provide an overcurrent threshold based on the system-input current; and
a switch control circuit configured to provide a plurality of switch control signals to control the first plurality of switching circuits, such that the first output voltage is regulated and each current flowing through the first plurality of switching circuits is limited based on the overcurrent threshold.

19. The multi-rail power supply system of claim 17, wherein the second voltage regulator further comprises:
a second plurality of switching circuits and a second controller, the second controller is configured to dynamically set a second overcurrent threshold according to the system-input current, to limit each current flowing through the second plurality of switching circuits.

20. The multi-rail power supply system of claim 17, wherein the first overcurrent threshold maintains at a first value in response to the system-input current being less than a first threshold, and the first overcurrent threshold decreases as the system-input current rises in response to the system-input current being higher than the first threshold.
